(19) United States
(12) Patent Application Publication
(10) Pub. No.: US 2006/0064525 A1
(43) Pub. Date: Mar. 23, 2006

(54) Remote control unit with a computer peripheral communication port

(76) Inventor: Devinder S. Ahluwalia, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/950,306

(22) Filed: Sep. 23, 2004

(51) Int. Cl. G06F 13/38

(52) U.S. Cl. 710/72

(57) ABSTRACT

A remote control unit is to be used by a person to control a media home computer, via a wireless link that couples the remote control unit to the computer. The remote control unit has a separate wireless communication port for two-way wireless data communications with a computer peripheral, and can support communications between the peripheral and the computer. Other embodiments are also described and claimed.

### BACKGROUND

An embodiment of the invention is related to the remote control of a home personal computer (PC) with multi-media playback and recording functions. Other embodiments are also described.

A current trend in the personal computer (PC) industry is to fit a personal computer, e.g. one that uses a PENTIUM processor by Intel Corp., Santa Clara, Calif., with the capability of playing and recording multi-media such as music and movie files. Such entertainment-capable PCs could have a high-speed or broadband connection (e.g. to the Internet) to download media files such as movie and music files. A satellite or broadcast cable connection could also be included, to receive digital television broadcasts such as television shows. A local connection such as a Universal Serial Bus (USB) link would be used for communication between the computer and external peripheral devices (also referred to as add-on devices) such as detached keyboards, mouse devices, external mass storage devices such as portable hard disk drives, digital cameras and portable solid-state audio players such as Motion Picture Experts Group-1 audio layer 3, MP3, players. The PC could also have connections to audio-visual, home entertainment consumer electronics devices located in other rooms of the home, such as a digital television display and a hi-fi sound system. An application program running in the PC would present a user interface for the user to select television shows, movies, or music for download, and then request their playback on the connected audio-visual devices. Such a user interface could be accessed via a PC remote control device over a wireless link. A user can, while sitting on a couch in her living room, navigate using the remote control device a television or music program guide that has been received by the PC and is being shown on a television screen in the living room.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 is a block diagram of an environment in which an embodiment of the invention is implemented.

FIG. 2 shows a top view of an example remote control unit having a computer peripheral communication port.

FIG. 3 is a software stack block diagram for an embodiment of the invention that uses USB ports in the remote control unit.

FIG. 4 is a screen shot of a device manager program showing the enumeration of USB ports in a remote control unit.

### DETAILED DESCRIPTION

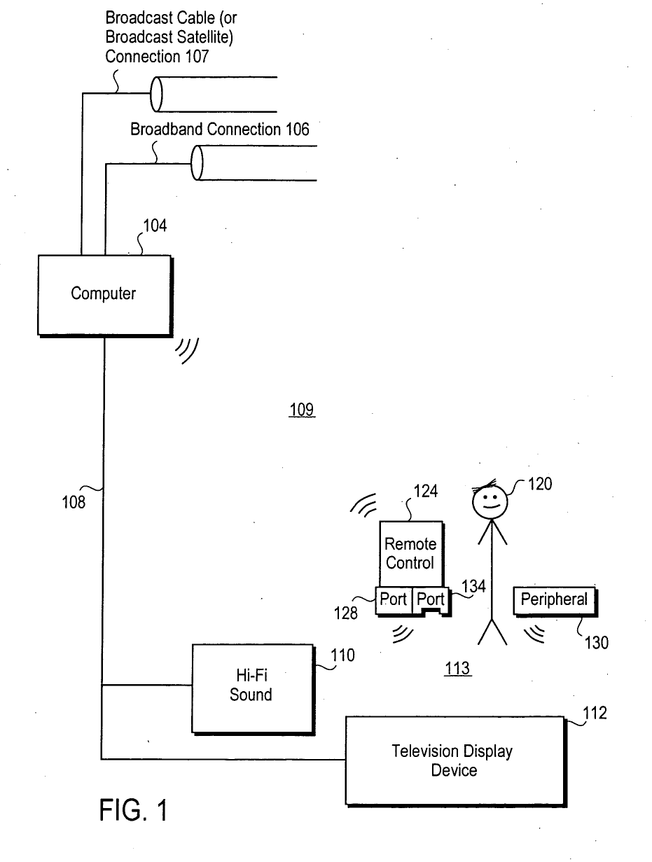

Beginning with FIG. 1, an environment for implementing an embodiment of the invention is shown. In this case, a home personal computer (PC-based) entertainment system with multi-media playback and recording function is shown. The environment includes a computer 104 which may be a PC unit that uses a PENTIUM processor by Intel Corp. of Santa Clara, Calif. This could be a desktop or laptop unit, single or multi-processor, with main memory in the form of, for example, dynamic random access memory (DRAM) modules. The computer 104 has a high speed or broadband connection 106 (e.g. to the Internet), and a broadcast satellite or cable connection 107, that may be used individually or collectively to download media files and television shows from a remote location of an authorized distributor of online content (not shown), e.g. an owner of a broadcast television channel, a cable television channel, and a satellite television operator. The term “download” refers here to the transfer of data into the computer for storage and processing, whereas “upload” refers to the transfer of data out of the computer over, for example, a broadband computer network connection or a local connection to a peripheral.

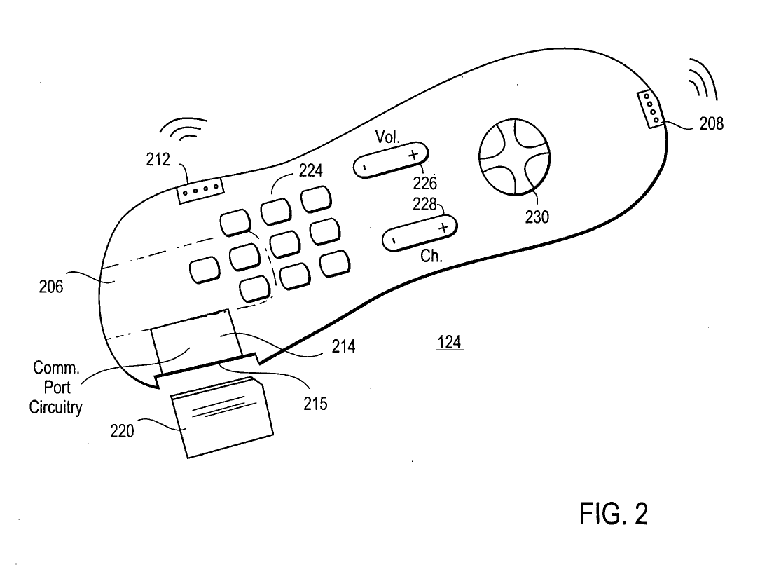

The computer 104 may be a media home personal computer, where it has advanced capabilities for playing or storing movies and songs in digital format. It may have the functionality that typically exists in a personal or digital video recorder, as well as the ability to play digital video disks (DVDs) and music compact discs (CDs). The computer 104 has a local connection 108 used for connecting to audio-visual devices in the home, including in this example a hi-fi sound system 110 and a television display device 112. The local connection 108 is used to deliver, for example, music and movies to be played back and shown in, for example, a living room of a user 120. The computer 104 is controlled by the user manipulating directly a remote control unit (RCU) 124. The RCU 124 has a direct wireless connection 109 to the computer 104, and may be portable. See FIG. 2 below illustrating an example RCU.

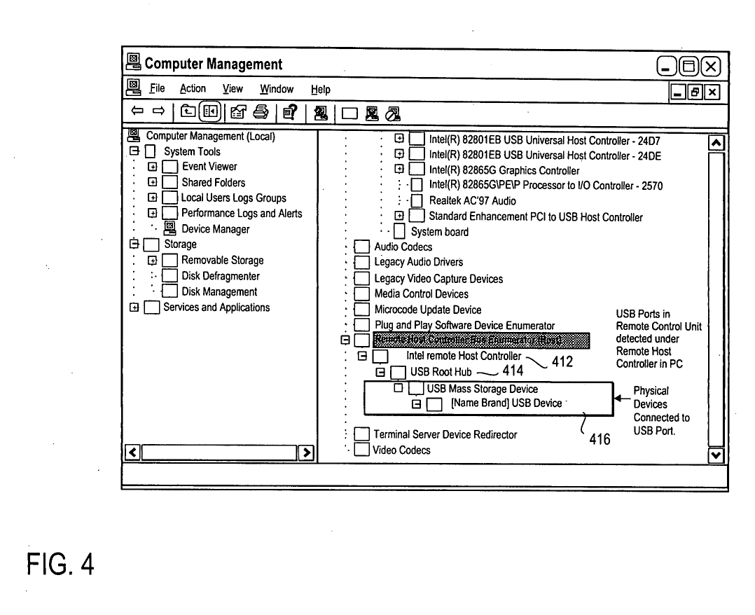

In addition to the capability of controlling the computer 104, the RCU 124 has a wireless communication port 128, for two-way wireless data communications with a computer peripheral 130. The RCU 124 has the needed circuitry and/or firmware to support communications aimed at the attached peripheral 130 from the computer 104 via the wireless connection 109, as commanded by the user 120 operating the RCU 124. The computer peripheral 130, also referred to as an external device or add-on device, may be a portable, handheld mass storage device (e.g. portable magnetic hard disk drive), a portable digital camera, or any other wireless peripheral device. The user 120 can easily attach and detach the peripheral 130 to the port 128 in a logical sense. The RCU 124 and the computer 104 are designed so that this attachment of the peripheral can be detected by software running in the computer 104. An example of such capability will be described below in connection with FIG. 4.

The RCU 124 may be equipped with an additional port 134 that makes a logical connection to a computer peripheral. An example of the latter type of port is a memory card reader (e.g. compact flashcard reader as used in digital cameras, or a secure digital (SD) memory card reader). In both cases, the port 128, 134 allows the user 120 to logically connect the peripheral 130 to the RCU 124, e.g. by inserting a SD card into part 134, without having to leave the room to fetch a peripheral cable or even stand up off the couch, to transfer data like media files between the peripheral 130, the port 128, 134 and the computer 104. The term “peripheral” in this case refers to not just active devices such as portable mass storage units and digital cameras, but also to passive device such as a solid state memory card.

Turning now to FIG. 2, an example RCU 124 is depicted. The RCU 124 in this case is self-powered, by a power source 206 installed in the unit. This power source may be, for example, a rechargeable battery. The RCU 124 in this case is portable and can be handheld by a person, while being used. At the front of the RCU 124 is a wireless transceiver circuit 208 to operate the wireless connection 109 (see FIG. 1). The transceiver circuitry 208 may be part of a wireless link such as an infrared port or dongle.

Towards the other end of the unit is another wireless transceiver circuit 212, to operate a separate wireless link with a peripheral (not shown). The transceiver circuit 212 is in this case part of a wireless communications port that can be used to logically attach and detach a peripheral to the computer 104, by way of a separate wireless connection. The wireless transceiver circuit 212 may be in accordance with a conventional, wireless USB port that allows a USB device to be connected for two-way data transfer with the RCU 124.

The RCU may also have communication port circuitry 214 as part of another integrated port, this time for receiving within a docking area 215 the electrical pins (not shown) of a solid state memory card 220. The communication port circuitry 214 may be part of a USB card reader, to transfer still images, for example, from a digital camera solid state memory card.

The RCU 124 has in this example a keypad 224, channel and volume control buttons 226, 228 as well as a general navigation joy stick 230 that help the user initiate and control downloads to and uploads from the computer 104.

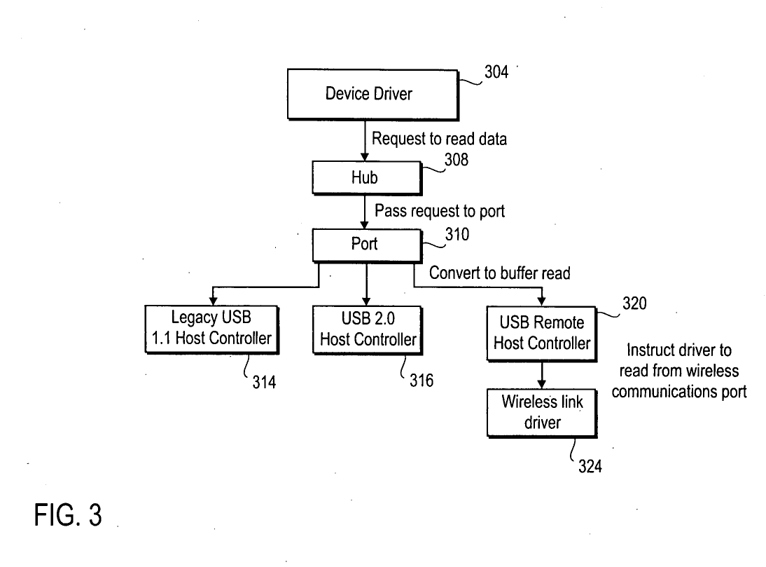

Turning now to FIG. 3, a software stack (operating system layers) in the computer 104 for accessing a peripheral communication port of the RCU 124 is shown. The particular example of FIG. 3 has a device driver 304 which sends requests to read data to a hub layer 308. The device driver 304 may be that of, for example, a mass storage device. The hub layer 308 may be a USB hub layer which passes the request to a USB port layer 310. Note how the hub layer 308 is one layer below the device driver and one layer above the port layer 310. The port layer 310 interfaces directly with different types of host controllers that may be present in the computer. A host controller performs several duties including reporting and managing the states of the USB devices that are connected to it, converting protocol and data information between a native format of the computer and a bitstream that is transmitted on a USB link, frame generation, processing requests for data transmission, and transmission error handling. For example, there may be a legacy USB host controller 314 that provides access to legacy USB devices and peripherals in the system, like a keyboard or mouse. A USB 2.0 host controller 316 (according to USB Specification 2.0, available from USB-IF, Portland, Oreg. 97221) provides access to more recent types of USB devices, while the USB remote host controller 320 provides access to a remote USB port in the RCU 124.

After the original request has been converted to a buffer read, the remote host controller 320 instructs a wireless link driver 324 to read from the wireless communications port that is in the RCU 124. This involves sending a request to the RCU 124 over the wireless connection 109 (see FIG. 1). The RCU 124 has the appropriate software that will respond to this read by collecting the requested data through either port 128 or port 134 (see FIG. 1).

According to an embodiment of the invention, the RCU 124 has the needed hardware and firmware to allow its peripheral communication port 128, 134 to interface with a peripheral, and also be detected by a device discovery process running in the computer. This device discovery process, or also referred to as device enumeration process, runs as part of the operating system software stack in the computer (e.g. a device manager program). FIG. 4 depicts a screen shot of an example device manager program user interface that may be running in the computer 104. The graphical user interface may be displayed on the television display device 112. This user interface may be navigated by the user, manipulating, for example, left and right arrow buttons, or the joy stick 230, on the RCU 124 (FIG. 1).

As seen in FIG. 4, the RCU may be detected and represented in the graphical user interface of the device manager by a “remote host controller” icon 412. The user may navigate the device manager program by sending commands, via the RCU, to the computer to, for example, expand a view depending from the remote host controller icon 412. A USB root hub that is in the RCU is also exposed, by an icon 414 that depends from that of the remote host controller. The devices connected to ports of the RCU may be detected and enumerated under the icon 414 tree (FIG. 4 shows icon 416 representing a device being detected). The device manager program may be entirely conventional, yet may still be able to expose the peripheral communication ports of the RCU. This may be achieved by the USB software stack, running on the computer, enumerating remote communication ports as well as the peripheral devices connected to them (if any). In the example shown in FIG. 4, the peripheral (physical device) connected to the remote USB port (icon 414) is a mass storage device (icon 416 which displays in this example a brand name of the particular mass storage device). Once the peripheral (physical device) has been enumerated and its drivers have been loaded in the computer, data may be transferred to and from the peripheral using, for example, the same wireless connection 109 (see FIG. 1).

An embodiment of the invention may be a machine readable medium having stored thereon instructions which program a processor to perform the operations of a process as described above. In other embodiments, such operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), not limited to Compact Disc Read-Only Memory (CD-ROMs), Read-Only Memory (ROMs), Random Access Memory (RAM), Erasable Programmable Read-Only Memory (EPROM), and a transmission over the Internet.

Further, a design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional microelectronic fabrication techniques are used, data representing a hardware model may be the data specifying the presence or absence of various features on different mask layers for masks used to produce the integrated circuit. In any representation of the design, the data may be stored in any form of a machine-readable medium.

The invention is not limited to the specific embodiments described above. For example, the remote control unit may be equipped with a single wireless communication port (e.g. a USB or smart card reader), or in another instance it may have more than one such port. As an alternative to USB, the port may be in compliance with Institute of Electrical and Electronics Engineers, IEEE, Standard 1394-1995. Accordingly, other embodiments are within the scope of the claims.

What is claimed is:

1. An apparatus comprising:
a remote control unit (RCU) to be used by a person to control a media home computer via a wireless link that couples the RCU to the computer, wherein the RCU has a wireless communication port for two way wireless data communications with a computer peripheral and is to support communications between the computer peripheral and computer.

2. The apparatus of claim 1 wherein the RCU is self-powered by a power source installed in the unit.

3. The apparatus of claim 2 wherein the power source is a rechargeable battery.

4. The apparatus of claim 2 wherein the RCU is to be used by the person to navigate a user interface of a media player program running in the computer.

5. The apparatus of claim 4 wherein the user interface is a graphical user interface.

6. The apparatus of claim 2 wherein the RCU is to be used by the person to navigate a user interface of a device manager program.

7. The apparatus of claim 1 wherein the communications port is a Universal Serial Bus (USB) compliant port.

8. An apparatus comprising:
a remote control unit (RCU) to be used to initiate and control downloads of image and music files to, and uploads of image and music files from, a computer, the RCU having a communication port that is to interface with a peripheral and can be detected by a device discovery process running in the computer.

9. The apparatus of claim 8 wherein the remote control unit is to be exposed as a remote host controller by a device manager of an operating system stack running in the computer.

10. The apparatus of claim 9 wherein the communication port can be identified by the device discovery process as a Universal Serial Bus (USB) port.

11. The apparatus of claim 8 wherein the communication port is a memory card reader.

12. A method comprising:
performing a device discovery procedure upon a computer; and
displaying a result of the device discovery procedure as an icon representing a root hub of a hierarchical point to point bus depending from an icon representing a remote host controller, and an icon representing a wireless peripheral device depending from the root hub icon.

13. The method of claim 12 wherein the root hub is a Universal Serial Bus (USB) root hub.

14. The method of claim 12 wherein the peripheral device is a portable handheld mass storage device.

15. The method of claim 12 wherein the peripheral device is a portable digital camera.

16. The method of claim 12 wherein displaying a result includes showing a brand name of the peripheral device.

17. The method of claim 12 wherein the result is displayed in response to receiving a command from a user of the computer to expand a view depending from the remote host controller icon.

18. An article of manufacture comprising:
a machine readable medium with instructions stored therein that, when executed by a processor of a wireless remote control unit (RCU), cause the RCU to signal, via its wireless link, a computer unit that an unused universal serial bus (USB) communication port within the RCU is available for use.

19. The article of manufacture of claim 18 wherein the instructions are to determine the type of peripheral device that is connected to the communication port and then signal the computer such information.

20. The article of manufacture of claim 18 wherein the instructions enable a user of the RCU to use the RCU to navigate a media program guide on a display screen.

21. A system comprising:
a computer unit having an operating system program installed therein, the operating system program having device discovery capability; and
a remote control unit (RCU) for the computer unit, the RCU to provide the computer unit, over a wireless communication link and during a device discovery procedure, information about a peripheral device that has established a separate communication link with the RCU.

22. The system of claim 21 wherein the peripheral device is a wireless USB peripheral.

23. The system of claim 21 wherein the RCU is to enable a user to select and transfer a media file from the peripheral device through the RCU and on to the computer unit.

24. The system of claim 23 wherein the RCU is to enable the user to select the play back of the media file from the computer unit to one of a hi-fi sound system and a television display screen.

25. The system of claim 23 wherein the peripheral device is a memory card.
